(19) United States
(12) Patent Application Publication
(10) Pub. No.: US 2010/0125298 A1
(43) Pub. Date: May 20, 2010

(54) MARKABLE BLANKET AND COMFORT SYSTEM

(76) Inventor: ELISABETH K. WHITNEY, San Francisco, CA (US)

Correspondence Address: Elisabeth Whitney, 24 Ashton Avenue, San Francisco, CA, 94112, US

(21) Appl. No.: 12/552,906

(22) Filed: Sep. 2, 2009

Related U.S. Application Data
(60) Provisional application No. 61/116,392, filed on Nov. 20, 2008.

(51) Int. Cl. A47G 9/02; A61J 17/00; A63H 3/00

(52) U.S. Cl. 606/234; 5/485; 446/268

(57) ABSTRACT

A children's comfort system is disclosed comprising a blanket made from a markable and washable fabric material body, a permanent or washable marker set removably attached to the blanket, an interchangeable comfort device connected to the blanket, and a markable and washable toy doll attached to the blanket.

### RELATED APPLICATIONS

This application claims the benefit of priority from and incorporates herein in its entirety, U.S. Provisional Patent Application No. 61/116,392, filed Nov. 21, 2008.

### BACKGROUND OF THE INVENTION

The present invention generally relates to bedding and more particularly, to a blanket and comfort system.

Children, such as babies and toddlers, can sometimes seek comfort from articles of fabric such as security blankets. When a child seeks refuge in a blanket, they are sometimes looking for a way to cope emotionally with circumstances or seeking to alleviate stress. Known security blankets can provide a warm fabric for comfort but can be limited in providing more constructive outlets or alternate forms of coping with a child's emotional issues.

As can be seen, there is a need for a blanket and comfort system that can provide alternative functionality over bedding alone.

### SUMMARY OF THE INVENTION

In one aspect of the present invention, a children's comfort system, comprises a blanket including a markable and washable fabric material body; a marker set removably attached to the blanket; a cloth pocket attached to the blanket; and a markable and washable toy doll attached to the blanket.

In another aspect of the present invention, a children's comfort system, comprises a blanket; a label affixed to the blanket; a message area including a printed message on the blanket; a pocket affixed to the blanket; a marker set stored in the pocket; a markable and washable toy doll attached to the blanket; and an interchangeable comfort device connected to the blanket.

These and other features, aspects and advantages of the present invention will become better understood with reference to the following drawings, description and claims.

### BRIEF DESCRIPTION OF THE DRAWINGS

FIG. 1 is a front view of a blanket according to an exemplary embodiment of the present invention; and

FIG. 2 is a back view of the blanket shown in FIG. 1 according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a blanket and a comfort system designed to meet the physical, creative, and emotional needs of young children. The blanket and comfort system may, in general, be used by young children as a warming article, a creative outlet, and a form of identification or information repository.

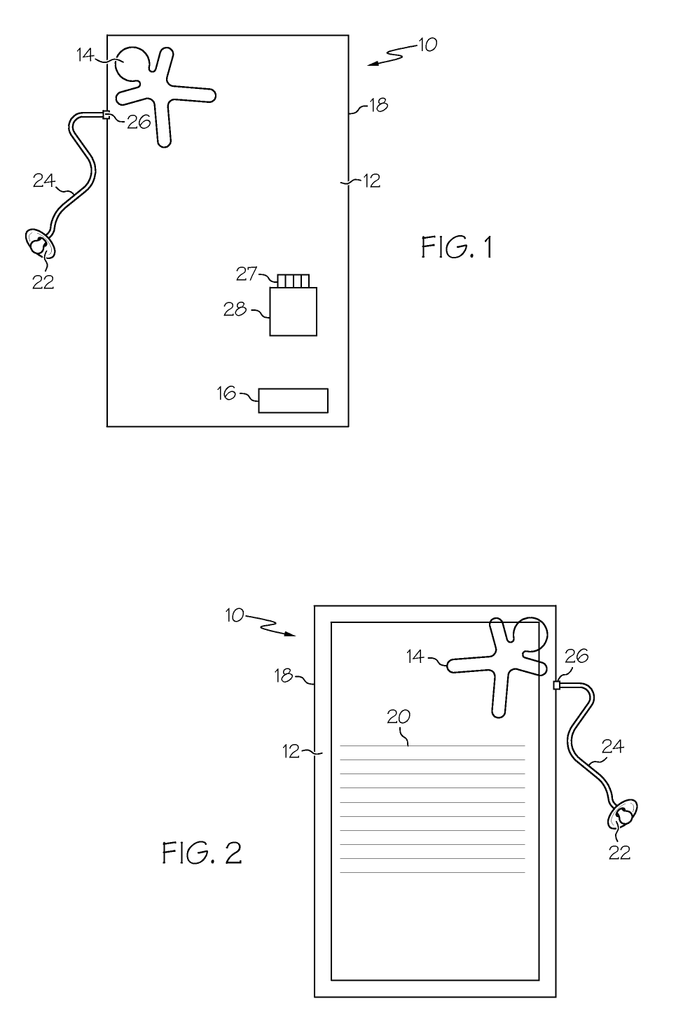

Referring to FIGS. 1 and 2, an exemplary embodiment of a comfort system 10, may include a blanket 18 comprising a fabric material body 12, a toy doll 14, a label area 16, a message area 20, and a cloth pocket 28 which securely closes and can hold a marker set or informational papers 27. The toy doll 14, label area 16 and message area 20 may be attached directly to the fabric material body 12.

The fabric material body 12 and the toy doll 14 may be a markable and washable light colored textile that may be repeatedly drawn on and decorated with the use of the washable or permanent marker set 27. The washable or permanent marker set 27 may be removably stored in the cloth pocket 28 and securably fastened within the pocket by use of a hook and loop system such as Velcro®. The fabric material body 12 may be washable to the extent that washable marker ink may be removed during wash to achieve a substantially clean and unmarked appearance on the blanket 18. Thus, a user may customize the appearance of the blanket 18 at will or use the blanket 18 as a wearable journal for entry of textual thoughts. The stuffed doll 14 may also be covered in a markable and washable material allowing a child to draw on the doll to create customized facial expressions and fashion appearances. The label area 16 may be initially blank providing an area for a child to write their name in and thus, take ownership of the blanket 18. Thus, when a blank canvas is desired on the fabric material body 12, or the stuffed doll 14, or the label area 16, the blanket 18 may be washed accordingly and these elements may be drawn on again at will by a child. The fabric material 12 and stuffed doll 14 may also be decorated with permanent markers to permanently keep information such as the child's name. The message area 20 may be a either a temporary or permanent message printed on to the fabric material body 12 such as emergency safety procedures, immunization schedules, or marketing messages, or name of child.

The stuffed doll 14, label area 16, attached cloth pocket 28 and message area 20 may be sewn or adhesively affixed permanently to the fabric material body 12 or be removably fastened to the fabric material body 12. The stuffed doll 14, may be removably attached to the blanket 18 by temporary fasteners such as hook and loop systems, e.g. Velcro®, and the permanent or washable marker set 27 may be stored in the pocket 28 providing means for keeping the marker set 27 with the comfort system 10 when the comfort system 10 is stored or transported.

In another exemplary embodiment, the comfort system 10 may also include a connector 26 for replaceable connection of interchangeable comfort devices 22. In the exemplary illustration shown, the comfort device 22 is a pacifier tethered by a tether 24 to the connector 26. However, it will be understood that other desired accessories may be connected to the connector 26 that may aid in comforting a child and allowing the child creative expression.

It should be understood, of course, that the foregoing relates to exemplary embodiments of the invention and that modifications may be made without departing from the spirit and scope of the invention as set forth in the following claims.

We claim:

1. A children's comfort system, comprising:
a blanket including a markable and washable fabric material body;
a marker set removably attached to the blanket;
a cloth pocket attached to the blanket; and
a markable and washable toy doll attached to the blanket.

2. The children's comfort system of claim 1, further comprising a label area affixed to the fabric material body.

3. The children's comfort system of claim 2 wherein the label area is blank.

4. The children's comfort system of claim 1, further comprising a message area including a printed message on the fabric material body.

5. The children's comfort system of claim 1, further comprising:
a connector fastened to the blanket; and
an interchangeable comfort device connected to the connector.

6. The children's comfort system of claim 5 wherein the interchangeable comfort device is a pacifier tethered to the connector.

7. The children's comfort system of claim 1 wherein the marker set includes washable-type markers.

8. A children's comfort system, comprising:
a blanket;
a label affixed to the blanket;
a message area including a printed message on the blanket;
a pocket affixed to the blanket;
a marker set stored in the pocket;
a markable and washable toy doll attached to the blanket; and
an interchangeable comfort device connected to the blanket.
